(19) United States
(12) Patent Application Publication
(10) Pub. No.: US 2025/0106671 A1
(43) Pub. Date: Mar. 27, 2025

(54) METHOD AND APPARATUS FOR QUALITY OF EXPERIENCE MEASUREMENT USING AREA SCOPE INFORMATION IN COMMUNICATION SYSTEM

(71) Applicant: Samsung Electronics Co., Ltd., Gyeonggi-do (KR)

(72) Inventors: Seungbeom JEONG, Gyeonggi-do (KR); Sangyeob JUNG, Gyeonggi-do (KR); Beomsik BAE, Gyeonggi-do (KR)

(21) Appl. No.: 18/895,956

(22) Filed: Sep. 25, 2024

(30) Foreign Application Priority Data
Sep. 27, 2023 (KR) 10-2023-0131003

(51) Int. Cl. H04W 24/10; H04W 24/02; H04W 76/20

(52) U.S. Cl. CPC H04W 24/10; H04W 24/02; H04W 76/20

(57) ABSTRACT

The disclosure relates to a fifth generation (5G) or sixth generation (6G) communication system for supporting a higher data transmission rate. A method performed by a user equipment (UE) in a communication system includes receiving, via radio resource control (RRC) signaling, an application layer measurement configuration, obtaining radio access network (RAN) visible application layer measurement reports after receiving the application layer measurement configuration, identifying whether a first signaling radio bearer (SRB) for transmission of the RAN visible application layer measurement reports is available, and discarding the RAN visible application layer measurement reports in case that the first SRB for the transmission of the RAN visible application layer measurement reports is not available.

### CROSS REFERENCE TO RELATED APPLICATION

The present application is based on and claims priority under 35 U.S.C. § 119 to Korean Patent Application No. 10-2023-0131003, which was filed in the Korean Intellectual Property Office on Sep. 27, 2023, the entire contents of which are incorporated herein by reference.

### BACKGROUND

### 1. Field

The disclosure relates generally to a wireless communication system and, more particularly, to a method and an apparatus for quality of experience (QoE) measurement using area scope information in a communication system.

### 2. Description of Related Art

Fifth generation (5G) mobile communication technologies define broad frequency bands such that high transmission rates and new services are possible and can be implemented not only in sub 6 gigahertz (GHz) bands such as 3.5 GHz, but also in above 6 GHz bands referred to as millimeter wave (mmWave) bands including 28 GHz and 39 GHz bands. In addition, it has been considered to implement sixth generation (6G) mobile communication technologies referred to as beyond 5G systems in terahertz (THz) bands (for example, 95 GHz to 3 THz bands) to realize transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for simplifying random access procedures for NR. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

However, there is a need in the art for improvement to the services provisioning in the existing communication system. That is, there is a need in the art for methods and apparatuses for QoE measurement using area scope information in communication system.

### SUMMARY

The disclosure has been made to address at least the above-mentioned problems and/or disadvantages and to provide at least the advantages described below.

Accordingly, an aspect of the disclosure is to provide an apparatus and a method of effectively providing services in a mobile communication system.

An aspect of the disclosure is to provide methods and apparatuses for QoE measurement using area scope information in communication system.

In accordance with an aspect of the disclosure, a method performed by a UE in a communication system includes receiving, via radio resource control (RRC) signaling, an application layer measurement configuration, obtaining radio access network (RAN) visible application layer measurement reports after receiving the application layer measurement configuration, identifying whether a first signaling radio bearer (SRB) for transmission of the RAN visible application layer measurement reports is available, and discarding the RAN visible application layer measurement reports in case that the first SRB for the transmission of the RAN visible application layer measurement reports is not available.

In accordance with an aspect of the disclosure, a UE in a communication system includes a transceiver, and a processor coupled with the transceiver and configured to receive, via radio resource control (RRC) signaling, an application layer measurement configuration, obtain radio access network (RAN) visible application layer measurement reports after receiving the application layer measurement configuration, identify whether a first signaling radio bearer (SRB) for transmission of the RAN visible application layer measurement reports is available, and discard the RAN visible application layer measurement reports in case that the first SRB for the transmission of the RAN visible application layer measurement reports is not available.

In accordance with an aspect of the disclosure, a method performed by a base station in a communication system includes transmitting a first radio resource control (RRC) message including an application layer measurement configuration, receiving a second RRC message including radio access network (RAN) visible application layer measurement reports after transmitting the application layer measurement configuration via a first signaling radio bearer (SRB) for the RAN visible application layer measurement reports in case that the first SRB for the RAN visible application layer measurement reports is available, and
obtaining the RAN visible application layer measurement reports in the second RRC message,
wherein, in case that the first SRB for a transmission of the RAN visible application layer measurement reports is not available, the RAN visible application layer measurement reports are discarded.

In accordance with an aspect of the disclosure, a base station in a communication system includes a transceiver and a processor coupled with the transceiver and configured to transmit a first radio resource control (RRC) message including an application layer measurement configuration, receive a second RRC message including radio access network (RAN) visible application layer measurement reports after transmitting the application layer measurement configuration via a first signaling radio bearer (SRB) for the RAN visible application layer measurement reports in case that the first SRB for the RAN visible application layer measurement reports is available is available, and obtain the RAN visible application layer measurement reports in the second RRC message, wherein, in case that the first SRB for a transmission of the RAN visible application layer measurement reports is not available, the RAN visible application layer measurement reports are discarded.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a structure of a mobile communication system according to an embodiment;

FIG. 2 illustrates radio access state transition in a mobile communication system according to an embodiment;

FIG. 3A illustrates a procedure of configuring/reporting signaling-based QoE measurement according to an embodiment;

FIG. 3B illustrates a procedure of application layer measurement reporting according to an embodiment;

FIG. 4 illustrates a procedure of configuring/reporting management-based QoE measurement according to an embodiment;

FIG. 5 illustrates a procedure of configuring and reporting RAN visible QoE measurement according to an embodiment;

FIG. 6 illustrates a configuration and report procedure for supporting QoE measurement in inactive and idle modes as well as a connected mode of a UE according to an embodiment;

FIG. 7 illustrates an SRB path in an SA situation according to an embodiment;

FIG. 8 illustrates an SRB path in a DC situation according to an embodiment;

FIG. 9 illustrates an internal structure of the UE to which embodiments of the disclosure are applied; and

FIG. 10 illustrates a structure of a BS to which embodiments of the disclosure are applied.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Throughout the specification, the same reference numeral refers to the same element.

Elements included in the disclosure are expressed as a singular or plural form according to the embodiment. However, the singular or plural expression is selected appropriately for the situation presented for convenience of description, and the disclosure is not limited by singular or plural elements. Even elements expressed in the plural form may be constructed in the singular form or even an element expressed in the singular form may be constructed in the plural form.

For convenience of description, some of the terms and names defined in the 3^{rd} generation partnership project (3GPP) standard (standard of 5G, NR, long term evolution (LTE), or a system similar thereto) may be used. The terms and names newly defined in a next-generation communication system (for example, 6G or beyond 5G system) to which the disclosure can be applied or used in the existing communication systems may be used. The use of the terms is not limited by the terms and names of the disclosure but may be equally applied to systems according to other standards and may be changed to another form without departing from the scope of the disclosure. Embodiments of the disclosure may be easily transformed and applied to other communication systems.

It may be understood that singular expressions such as one and the include plural expression unless clearly indicate otherwise in an embodiment.

Herein, the terms include, have, or the like is intended to indicate that characteristics, numbers, steps, operations, elements, or components disclosed in the specification or a combination thereof exists. Rather, the terms should be understood so as not to pre-exclude the existence or additionality of one or more other characteristics, numbers, steps, operations, elements, components, or a combination thereof.

The terms associated with, associated therewith, and derivatives thereof used in an embodiment of the disclosure may indicate include, be included within, interconnect with, contain, be contained within, connect to or with, couple to or with, be communicated with, cooperate with, interleave, juxtapose, be proximate to, be bound to or with, have, and have a property of.

In the disclosure, the expressions greater than or less than are used to determine whether a specific condition is satisfied or fulfilled, but are used only to indicate an example, and do not exclude the following description. A condition indicating greater than or equal to may be replaced with greater than, a condition indicating equal to or less than may be replaced with less than, a condition indicating greater than or equal to and less than may be replaced with greater than and equal to or less than.

The disclosure describes various embodiments using the terms used in some communication standards defined by the 3GPP, but this is only an example. Embodiments of the disclosure may be easily transformed and applied to other communication systems.

In the disclosure, a terminal (or a communication terminal) is a subject communicating with a BS or another terminal and may be referred to as a mode a UE, a next generation UE (NG UE), a mobile station (MS), a device, a terminal, or the like. The UE may include at least one of a smartphone, a tablet personal computer (PC)C, a mobile phone, a video phone, an electronic book reader, a desktop PC, a laptop PC, a netbook computer, a personal data assistant (PDA), a portable media player (PMP), an MP3 player, a mobile medical device, a camera, or a wearable device. The UE may include at least one of a television, a digital video disk (DVD) player, an audio, a refrigerator, an air conditioner, a vacuum cleaner, an oven, a microwave oven, a washing machine, an air purifier, a set-top box, a home automation control panel, a security control panel, a media box, a game console, an electronic dictionary, an electronic key, a camcorder, or an electronic album.

The UE may include at least one of various medical devices (for example, various portable medical measuring devices (a blood glucose monitoring device, a heart rate monitoring device, a blood pressure measuring device, a body temperature measuring device, and the like), a magnetic resonance angiography (MRA), a magnetic resonance imaging (MRI), a computed tomography (CT) scanning machine, an ultrasonic machine, or the like), a navigation device, a satellite navigation system (global navigation satellite system (GNSS)), an event data recorder (EDR), a flight data recorder (FDR), a vehicle infotainment devices, an electronic devices for a ship (for example, a navigation device for a ship, a gyro-compass, and the like), avionics, security devices, an automotive head unit, a robot for home or industry, a drone, an ATM in financial institutions, point of sales (POS) in a shop, or internet device of things (for example, a light bulb, various sensors, a sprinkler device, a fire alarm, a thermostat, a streetlamp, a toaster, sporting goods, a hot water tank, a heater, a boiler, and the like). The UE may include various types of multimedia systems capable of performing a communication function. The disclosure is not limited to the above description.

Herein, the BS communicates with the UE and allocates resources to the UE, may have various forms, and may be referred to as a NodeB (NB), an NG RAN, an access point (AP), a transmission reception point (TRP), a radio access unit, a BS controller, a node in the network, or the like. Alternatively, the BS may be referred to as a central unit (CU) or a distributed unit (DU) according to function separation. However, the disclosure is not limited thereto.

Herein, an RRC message may be referred to as high-level information, a high-level message, a high-level signal, high-level signaling, high-layer signaling, or higher-layer signaling, but the disclosure is not limited thereto and the RRC message may be referred to as the term having the same or similar meaning.

Data may be referred to as user data, user plane (UP) data, or application data, or may be referred to as the term having a meaning that is the same as or similar to a signal transmitted and received through a data radio bearer (DRB).

In addition, a direction of data transmitted from the UE may be referred to as an uplink, and a direction of data transmitted to the UE may be referred to as a downlink. Accordingly, in the case of uplink transmission, a transmitter may refer to a UE, and a receiver may refer to a BS or a specific network entity in a communication system. Alternatively, in the case of downlink transmission, the transmitter may refer to a BS or a specific network entity in the communication system, and the receiver may refer to a UE.

Hereinafter, for convenience of description, targets that exchange information to control access and manage states are collectively described as network functions (NFs), such as an access and mobile management function (AMF) device, a session management function (SMF) device, and a network slice selection function (NSSF) device. However, embodiments of the disclosure may be equally applied to when the NF is implemented as an AMF instance, SMF instance, NSSF instance, or the like.

An instance may indicate when a specific NF exists in the form of a software code and physical or/and logical resources may be allocated from a computing system to perform an NF function and executed by a physical computing system, a specific computing system existing in a core network. Accordingly, an AMF instance, an SMF instance, or an NSSF instance may indicate that physical or/and logical resources may be used for the AMF, SMF, or NSSF operation after being allocated from a specific computing system existing in a core network. As a result, the AMF instance, the SMF instance, and the NSSF instance receiving physical or/and logical resources for the AMF, SMF, and NSSF operation from the specific computing system existing in the core network may perform the same operation as that in when physical AMF, SMF, and NSSF devices exist.

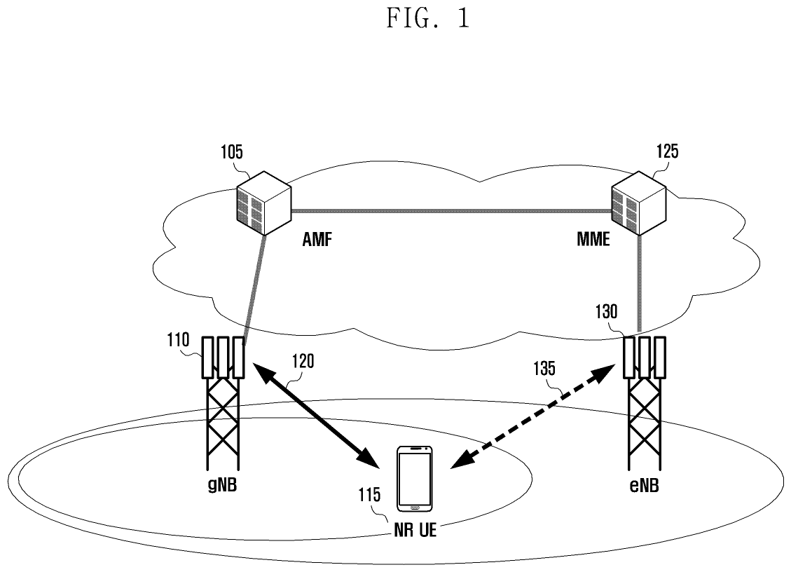

FIG. 1 illustrates a structure of a mobile communication system according to an embodiment.

Referring to FIG. 1, a radio access network of mobile communication system (new radio (NR)) is constituted by a base station (new radio node B (gNB)) 110 and an AMF 105 (new radio core network). A UE 115 (hereinafter, referred to as an NR UE, a UE, or a terminal) accesses an external network through the gNB 110 and the AMF 105. The mobile communication system may be an NG mobile communication system, and the base station may be an NG base station.

In FIG. 1, the gNB corresponds to an evolved Node B (eNB) of the conventional LTE system. The gNB may be connected to the NR UE through a radio channel and may provide a better service than the conventional node B as indicated by reference number 120. Since all user traffic is served through a shared channel in the NG mobile communication system disclosed herein, a device for collecting and scheduling status information of buffer statuses, available transmission power statuses, and channel statuses of UEs is required, which is handled by the gNB 110. One gNB generally controls a plurality of cells. The gNB may have a bandwidth wider than the conventional maximum bandwidth to implement super-high-speed data transmission compared to conventional LTE and orthogonal frequency division multiplexing (OFDM) may be additionally combined with beamforming technology through radio access technology. An adaptive modulation and coding (AMC) scheme of determining a modulation scheme and a channel coding rate is applied depending on the channel status of the UE.

The AMF 105 performs functions of supporting mobility, configuring a bearer, configuring QoS, and the like. The AMF serves to perform various control functions as well as a mobility management function for the UE and is connected to a plurality of BSs. A mobile communication system as disclosed herein may interwork with the existing LTE system, and the AMF is connected to the MME 125 through a network interface. The MME is connected to the eNB 130 which is the conventional BS. The UE supporting LTE-NR dual connectivity may transmit and receive data while maintaining the connection not only to the gNB but also to the eNB as indicated by reference numeral 135.

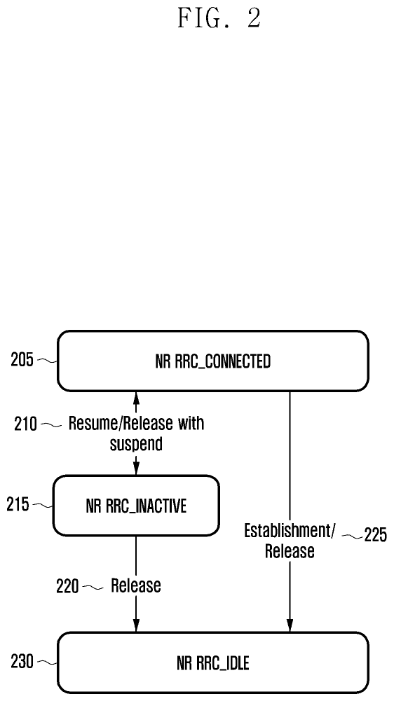

FIG. 2 illustrates radio access state transition in a mobile communication system according to an embodiment.

In the mobile communication system herein, there are three RRC states. A connected mode (RRC_CONNECTED) 205 is a radio access state in which the UE can transmit and receive data. An idle mode (RRC_IDLE) 230 is a radio access state in which the UE monitors whether paging is transmitted to the UE itself. The two modes are radio access states applied to the conventional LTE system, and detailed technology thereof is the same as that of the conventional LTE system.

In the mobile communication system, an inactive (RRC_INACTIVE) radio access state 215 is newly defined. In the radio access state, UE context is maintained in the BS and the UE and RAN-based paging is supported. Characteristics of the new radio access state are listed below.
Cell re-selection mobility
CN—NR RAN connection (both C/U-planes (control plane/user plane)) has been established for UE
The UE AS (access stratum) context is stored in at least one gNB and the UE
Paging is initiated by NR RAN
RAN-based notification area is managed by NR RAN
NR RAN knows the RAN-based notification area to which the UE belongs

The UE in the inactive radio access state may transition to the connected mode or the idle mode by using a specific procedure. According to a resume process, the inactive mode switches to the connected mode, and the connected mode switches to the inactive mode using a release procedure including suspend configuration information 210. The procedure is performed by transmission and reception of one or more RRC messages between the UE and the BS and is constituted by one or more steps. After resume, it is possible to switch the inactive mode to the idle mode through a release procedure 220. Switching between the connected mode and the idle mode may follow the conventional LTE technology. That is, through the establishment or release procedure 225, switching between the modes is performed.

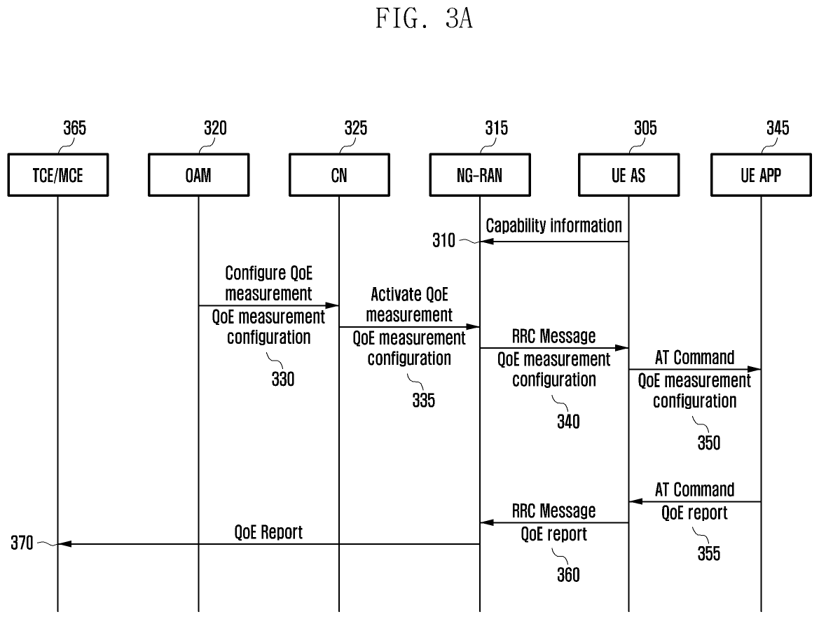

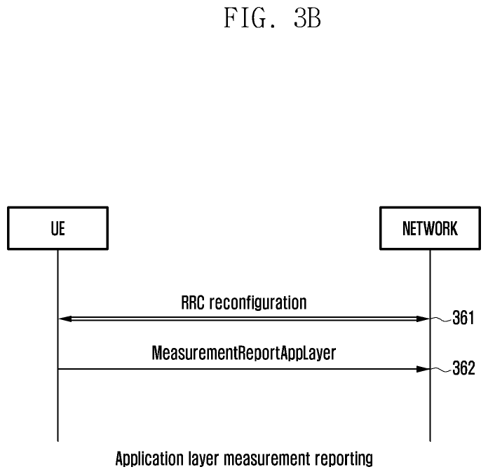

FIG. 3A illustrates a procedure of configuring/reporting signaling-based QoE measurement according to an embodiment.

Referring to FIG. 3A, an access stratum (AS) 305 of the UE may transmit information (for example, qoe-Streaming-MeasReport, qoe-MTSI-MeasReport, and qoe-VR-MeasReport) indicating whether QoE measurement is supported for each service type (for example, streaming, multimedia telephony service for Internet protocol (IP) multimedia subsystem (MTSI), and VR to a BS (or NG-RAN) 315 through a UE capability message (for example, UECapabilityInformation) in step 310. Before the UE transmits the UE capability message, the BS may transmit a message (for example, UECapabilityEnquiry) for making a request for the UE capability message to the UE. The UE may report whether RAN visible QoE measurement is supported for each service type, such as streaming or VR (for example, ran-VisibleQoE-Streaming-MeasReport, or ran-VisibleQoE-VR-MeasReport) to the BS through the UE capability message. The UE may report whether UL RRC segmentation for a QoE report message is supported (for example, ul-MeasurementReportAppLayer-Seg) to the BS through the UE capability message. The UE capability message includes abstract syntax notation one (ASN.1) information shown in Table 1 below, and description of relevant parameters is as shown in Table 2 below.

TABLE 1
QoE-Parameters-r17 ::= SEQUENCE {

| | |
|---|---|
| qoe-Streaming-MeasReport-r17 | ENUMERATED { supported } |

OPTIONAL,

| | |
|---|---|
| qoe-MTSI-MeasReport-r17 | ENUMERATED { supported} |

OPTIONAL,

| | |
|---|---|
| qoe-VR-MeasReport-r17 | ENUMERATED { supported } |

OPTIONAL,

| | |
|---|---|
| ran-VisibleQoE-Streaming-MeasReport-r17 | ENUMERATED { supported } |

OPTIONAL,

| | |
|---|---|
| ran-VisibleQoE-VR-MeasReport-r17 | ENUMERATED { supported } |

OPTIONAL,

| | |
|---|---|
| ul-MeasurementReportAppLayer-Seg-r17 | ENUMERATED { supported } |

OPTIONAL,
...
}

TABLE 2
4.2.20 QoE measurement parameters

| | | | FDD- | FR1- |
|---|---|---|---|---|
| | | | TDD | FR2 |
| Definitions for parameters | Per | M | DIFF | DIFF |
| qoe-Streaming-MeasReport-r17 | UE | No | No | No |
| Indicates whether the UE supports NR Q E | | | | |
| Measurement Collection for streaming | | | | |
| services, see the relevant standard. | | | | |
| qoe-MTSI-MeasReport-r17 | UE | No | No | No |
| Indicates whether the UE supports NR QoE | | | | |
| Measurement Collection for MTSI services, | | | | |
| see the relevant standard. | | | | |
| qoe-VR-MeasReport-r17 | UE | No | No | No |
| Indicates whether the UE supports NR QoE | | | | |
| Measurement Collection for VR services, | | | | |
| see the relevant standard. | | | | |
| ran-VisibleQoE-Streaming-MeasReport-r17 | UE | No | No | No |
| Indicates whether the UE supports RAN | | | | |
| visible QoE Measurement Collection for | | | | |
| streaming services. | | | | |
| ran-VisibleQoE-VR-MeasReport-r17 | UE | No | No | No |
| Indicates whether the UE supports RAN | | | | |
| visible QoE Measurement Collection | | | | |
| for VR services. | | | | |
| ul-MeasurementReportAppLayer-Seg-r17 | UE | No | No | No |
| Indicates whether the UE supports | | | | |
| RRC segmentation of the | | | | |
| MeasurementReportAppLayer message | | | | |
| in UL, as specified in the relevant standard. | | | | |

Service types that can be supported in LTE may include streaming and multimedia telephony service for IMS (MTSI) (IP multimedia subsystem), and in the case of NR, it was defined that a VR service is further supported in addition to the service types that can be supported in LTE and it was defined that services such as multimedia broadcast multicast service (MBMS), XR, and the like can be additionally supported in the later release.

Operations, administration, and maintenance (OAM) 320 may provide QoE measurement configuration information to a core network (CN) 325 in step 330. The CN 325 receiving the configuration information may activate QoE measurement by transmitting configuration information to the NG-RAN 315 in step 335.

The NG-RAN 315 receiving the configuration information from the CN 325 may transfer the QoE configuration information to the AS 305 of the UE through an RRC message (for example, an RRCReconfiguration or RRCResume message) in step 340. The RRC message may include IEs (APPLayerMeasConfig) as shown in Table 3 below, and description of relevant parameters is as shown in Table 4 below.

TABLE 3
AppLayerMeasConfig
The IE AppLayerMeasConfig indicates configuration of application layer measurements.
AppLayerMeasConfig information element

-- ASN1START
-- TAG-APPLAYERMEASCONFIG-START

| | |
|---|---|
| AppLayerMeasConfig-r17 ::= | SEQUENCE { |

| | |
|---|---|
| measConfigAppLayerToAddModList-r17 | SEQUENCE (SIZE |

| | |
|---|---|
| (1..maxNrofAppLayerMeas-r17)) OF MeasConfigAppLayer-r17 | OPTIONAL, -- Need |

N

| | |
|---|---|
| measConfigAppLayerToReleaseList-r17 | SEQUENCE (SIZE |

| | |
|---|---|
| (1..maxNrofAppLayerMeas-r17)) OF MeasConfigAppLayerId-r17 | OPTIONAL, -- Need |

N

| | |
|---|---|
| rrc-SegAllowed-r17 | ENUMERATED {enabled} |

OPTIONAL, -- Need R
...
}

| | |
|---|---|
| MeasConfigAppLayer-r17 ::= | SEQUENCE { |

| | |
|---|---|
| measConfigAppLayerId-r17 | MeasConfigAppLayerId-r17, |
| measConfigAppLayerContainer-r17 | OCTET STRING (SIZE (1..8000)) |

OPTIONAL, -- Need N

| | |
|---|---|
| serviceType-r17 | ENUMERATED {streaming, mtsi, vr, |

spare5, spare4, spare3, spare2, spare1 } OPTIONAL, -- Need M

| | |
|---|---|
| pauseReporting | BOOLEAN |

OPTIONAL, -- Need M

| | |
|---|---|
| transmissionOfSessionStartStop | BOOLEAN |

OPTIONAL, -- Need M

| | |
|---|---|
| ran-VisibleParameters-r17 | SetupRelease {RAN-VisibleParameters-r17} |

OPTIONAL, -- Need M
...
}

| | |
|---|---|
| RAN-VisibleParameters-r17 ::= | SEQUENCE { |

| | |
|---|---|
| ran-VisiblePeriodicity-r17 | ENUMERATED {ms120, ms240, ms480, |
| ms640, ms1024} | OPTIONAL, -- Need S |

| | |
|---|---|
| numberOfBufferLevelEntries-r17 | INTEGER (1..8) |

OPTIONAL, -- Need R

| | |
|---|---|
| reportPlayoutDelayForMediaStartup-r17 | BOOLEAN |

OPTIONAL, -- Need M
...
}
-- TAG-APPLAYERMEASCONFIG-STOP
-- ASN1STOP

TABLE 4
AppLayerMeasConfig field descriptions
measConfigAppLayerContainer
The field contains configuration of application layer measurements, see
the relevant standard.
pauseReporting
The field indicates whether the transmission of
measReportAppLayerContainer is paused or not.
ran-VisibleParameters
The field indicates whether RAN visible application layer measurements
shall be reported or not. The field is optionally present when serviceType
is set to streaming or vr. Otherwise, it is absent.
rrc-SegAllowed
This field indicates that RRC segmentation of
MeasurementReportAppLayer is allowed. It may be present only if the
UE supports RRC segmentation of the MeasurementReportAppLayer
message in UL.
serviceType
Indicates the type of application layer measurement. Value streaming
indicates Quality of Experience Measurement Collection for streaming
services, value mtsi indicates Quality of Experience Measurement
Collection for MTSI, and value vr indicates Quality of Experience
Measurement Collection for VR service (see the relevant standard). The
network always configures serviceType when application layer
measurements are initially configured and at fullConfig.
transmissionOfSessionStartStop
The field indicates whether the UE shall transmit indications when
sessions in the application layer start and stop. The UE transmits a
session start indication upon configuration of this field if a session
already has started in the application layer.
RAN-VisibleParameters field descriptions
numberOfBufferLevelEntries
The field contains the maximum number of buffer level entries that can
be reported for RAN visible application layer measurements.
ran-VisiblePeriodicity
The field indicates the periodicity of RAN visible reporting. Value ms120
indicates 120 ms, value ms240 indicates 240 ms and so on.
reportPlayoutDelayForMediaStartup
The field indicates whether the UE shall report Playout Delay for Media
Startup for RAN visible application layer measurements.

The operation of the AS 305 of the UE receiving the QoE configuration information from the NG-RAN through the RRC message may follow the description in Table 5 below.

TABLE 5
5.3.5.13d Application layer measurement configuration

The UE shall:

| | |
|---|---|
| 1> | if measConfigAppLayerToReleaseList is included in appLayerMeasConfig within |
| | RRCReconfiguration or RRCResume: |

| | |
|---|---|
| 2> | for each measConfigAppLayerId value included in the |
| | measConfigAppLayerToReleaseList: |

| | |
|---|---|
| 3> | forward the measConfigAppLayerId and inform upper layers about the release of the |
| | application layer measurement configuration including any RAN visible application |
| | layer measurement configuration; |
| 3> | discard any application layer measurement report received from upper layers; |
| 3> | consider itself not to be configured to send application layer measurement report for |
| | the measConfigAppLayerId. |

| | |
|---|---|
| 1> | if measConfigAppLayerToAddModList is included in appLayerMeasConfig within |
| | RRCReconfiguration or RRCResume: |

| | |
|---|---|
| 2> | for each measConfigAppLayerId value included in the |
| | measConfigAppLayerToAddModList: |

| | |
|---|---|
| 3> | if measConfigAppLayerContainer is included for the corresponding |
| | MeasConfigAppLayer configuration: |

| | |
|---|---|
| 4> | forward the measConfigAppLayerContainer, the measConfigAppLayerId and |
| | the serviceType to upper layers considering the serviceType; |

| | |
|---|---|
| 3> | consider itself to be configured to send application layer measurement report for the |
| | measConfigAppLayerId in accordance with 5.7.16 in Table 8 below; |
| 3> | forward the transmissionOfSessionStartStop, if configured, and |
| | measConfigAppLayerId to upper layers considering the serviceType; |
| 3> | if ran-VisibleParameters is set to setup and the parameters have been received: |

| | |
|---|---|
| 4> | forward the measConfigAppLayerId, the ran-VisiblePeriodicity, if |
| | configured, the numberOfBufferLevelEntries, if configured, and the |
| | reportPlayoutDelayForMediaStartup, if configured, to upper layers |
| | considering the serviceType; |

| | |
|---|---|
| 3> | else if ran-VisibleParameters is set to release: |

| | |
|---|---|
| 4> | forward the measConfigAppLayerId and inform upper layers about the release |
| | of the RAN visible application layer measurement configuration; |

| | |
|---|---|
| 3> | if pauseReporting is set to true: |

| | |
|---|---|
| 4> | if at least one segment, but not all segments, of a segmented |
| | MeasurementReportAppLayer message containing an application layer |
| | measurement report associated with the measConfigAppLayerId has been |
| | submitted to lower layers for transmission: |

| | |
|---|---|
| 5> | submit the remaining segments of the MeasurementReportAppLayer |
| | message to lower layers for transmission; |

| | |
|---|---|
| 4> | suspend submitting application layer measurement report containers to lower |
| | layers for the application layer measurement configuration associated with the |
| | measConfigAppLayerId; |
| 4> | store any previously or subsequently received application layer measurement |
| | report containers associated with the measConfigAppLayerId for which no |
| | segment, or full message, has been submitted to lower layers for transmission; |

| | |
|---|---|
| 3> | else if pauseReporting is set to false and if transmission of application layer |
| | measurement report containers has previously been suspended for the application |
| | layer measurement configuration associated with the measConfigAppLayerId: |

| | |
|---|---|
| 4> | submit stored application layer measurement report containers to lower layers, |
| | if any, for the application layer measurements configuration associated with |
| | the measConfigAppLayerld; |
| 4> | resume submitting application layer measurement report containers to lower |
| | layers for the application layer measurement configuration associated with the |
| | measConfigAppLayerId; |

NOTE 1: The UE may discard reports when the memory reserved for storing application

layer measurement reports becomes full.

NOTE 2: The transmission of RAN visible application layer measurement reports is not

paused when pauseReporting is set to true.

As described above, in the case of the QoE measurement configuration included in measConfigAppLayerToAddModList, the AS layer 305 of the UE may transfer some or all of the configuration information to an upper layer of the UE or an application layer (UE APP 345) through an AT Command in step 350. The AS layer 305 of the UE may send the AT Command that instructs/orders deletion of the configuration information stored for the QoE measurement configuration included in measConfigAppLayerToAddReleaseList to the APP 345 of the UE.

The APP 345 of the UE may perform QoE measurement according to the received configuration information. The UE APP 345 may report a result of the measurement according to the configuration information to the UE AS 305 through the AT command in step 355.

The UE AS 305 receiving the measurement result report from the UE APP may report the measurement result to the NG-RAN 315 through an RRC message (for example, a MeasurementReportAppLayer message) in step 360. SRB 4 may be used to report the QoE measurement result. The MeasurementReportAppLayer message may include ASN.1 information as shown in Table 6 below, and description of relevant parameters is as shown in Table 7 below.

TABLE 6
MeasurementReportAppLayer
The MeasurementReportAppLayer message is used for sending application
layer measurement report.
Signaling radio bearer: SRB4
RLC-SAP: AM
Logical channel: DCCH
Direction: UE to Network
MeasurementReportAppLayer message

-- ASN1START
-- TAG-MEASUREMENTREPORTAPPLAYER-START

| | |
|---|---|
| MeasurementReportAppLayer-r17 ::= | SEQUENCE { |
| criticalExtensions | CHOICE { |
| measurementReportAppLayer-r17 | MeasurementReportAppLayer-r17-IEs, |
| criticalExtensionsFuture | SEQUENCE { } |

}
}

| | |
|---|---|
| MeasurementReportAppLayer-r17-IEs := | SEQUENCE { |
| measurementReportAppLayerList-r17 | MeasurementReportAppLayerList-r17, |
| lateNonCriticalExtension | OCTET STRING |

OPTIONAL,

| | |
|---|---|
| nonCriticalExtension | SEQUENCE{ } |

OPTIONAL
}
MeasurementReportAppLayerList-r17 ::= SEQUENCE (SIZE (1..maxNrofAppLayerMeas-
r17)) OF MeasReportAppLayer-r17
MeasReportAppLayer-r17 ::= SEQUENCE {

| | |
|---|---|
| measConfigAppLayerId-r17 | MeasConfigAppLayerId-r17, |
| measReportAppLayerContainer-r17 | OCTET STRING |

OPTIONAL,

| | |
|---|---|
| appLayerSessionStatus-r17 | ENUMERATED {started, stopped} |

OPTIONAL,

| | |
|---|---|
| ran-VisibleMeasurements-r17 | RAN-VisibleMeasurements-r17 |

OPTIONAL
}

| | |
|---|---|
| RAN-VisibleMeasurements-r17 ::= | SEQUENCE { |
| appLayerBufferLevelList-r17 | SEQUENCE (SIZE (1..8)) OF |
| AppLayerBufferLevel-r17 | OPTIONAL, |
| playoutDelayForMediaStartup-r17 | INTEGER (0..30000) |

OPTIONAL,

| | |
|---|---|
| protocol data unit (pdu)-SessionIdList-r17 | SEQUENCE (SIZE |
| (1..maxNrofPDU-Sessions-r17)) OF PDU-SessionID | OPTIONAL, |

...
}
AppLayerBufferLevel-r17 ::= INTEGER (0..30000)
-- TAG-MEASUREMENTREPORTAPPLAYER-STOP
-- ASN1STOP

TABLE 7
MeasurementReportAppLayer field descriptions

appLayerBufferLevelList
The field indicates a list of application layer buffer levels, and each
AppLayerBufferLevel indicates the application layer buffer level in ms.
Value 0 corresponds to 0 ms, value 1 corresponds to 10 ms, value 2
corresponds to 20 ms and so on. If the buffer level is greater than the
maximum value of 30000 (5 minutes), the UE reports 30000.
appLayerSessionStatus
Indicates that an application layer measurement session in the application
layer starts or ends.
playoutDelayForMediaStartup
Indicates the application layer playout delay for media start-up in ms.
Value 0 corresponds to 0 ms, value 1 corresponds to 1 ms, value 2
corresponds to 2 ms and so on. If the playout delay for media start-up is
greater than the maximum value of 30000 ms, the UE reports 30000.
measReportAppLayerContainer
The field contains application layer measurement report, see the
relevant standard.
pdu-SessionIdList
Contains the identity of the PDU session, or the identities of the PDU
sessions, used for application data flows subject to the RAN visible
application layer measurements.

FIG. 3B illustrates a procedure of application layer measurement reporting according to an embodiment.

Referring to FIG. 3B, a detailed procedure of the UE AS reporting the measurement result is shown in Table 8 below.

TABLE 8
5.7.16 Application layer measurement reporting

| | |
|---|---|
| 5.7.16.1 | General |

In FIG. 3B, the procedure of application layer measurement reporting is performed to send
application layer measurement reports to the network.

| | |
|---|---|
| 5.7.16.2 | Initiation |

A UE capable of application layer measurement reporting in RRC_CONNECTED may initiate
the procedure when configured with application layer measurement, i.e. when
appLayerMeasConfig and SRB4 have been configured by the network.
Upon initiating the procedure, the UE shall:

| | |
|---|---|
| 1> | for each measConfigAppLayerId: |

| | |
|---|---|
| 2> | if the UE AS has received application layer measurement report from upper layers |
| | which has not been transmitted; and |
| 2> | if the application layer measurement reporting has not been suspended for the |
| | measConfigAppLayerId associated with the application layer measurement report |
| | according to clause 5.3.5.13d: |

| | |
|---|---|
| 3> | set the measReportAppLayerContainer in the MeasurementReportAppLayer |
| | message to the received value in the application layer measurement report; |

| | |
|---|---|
| 2> | set the measConfigAppLayerId in the MeasurementReportAppLayer message to the |
| | value of the measConfigAppLayerId received together with application layer |
| | measurement report information; |
| 2> | if session start or stop information has been received from upper layers for the |
| | measConfigAppLayerId: |

| | |
|---|---|
| 3> | set the appLayerSessionStatus to the received value of the application layer |
| | measurement information; |

| | |
|---|---|
| 2> | if RAN visible application layer measurement report has been received from upper |
| | layers: |

| | |
|---|---|
| 3> | for each appLayerBufferLevel value in the received RAN visible application layer |
| | measurement report: |

| | |
|---|---|
| 4> | set the appLayerBufferLevel values in the appLayerBufferLevelList to the buffer |
| | level values received from the upper layer in the order with the first |
| | appLayerBufferLevel value set to the newest received buffer level value, the |
| | second appLayerBufferLevel value set to the second newest received buffer |
| | level value, and so on until all the buffer level values received from the upper |
| | layer have been assigned or the maximum number of values have been set |
| | according to appLayerBufferLevel, if configured; |

| | |
|---|---|
| 3> | set the playoutDelayForMediaStartup to the received value in the RAN visible |
| | application layer measurement report, if any; |
| 3> | for each PDU session ID value indicated in the received RAN visible application |
| | layer measurement report, if any: |

| | |
|---|---|
| 4> | set the PDU-SessionID field in the pdu-SessionIdList to the indicated PDU |
| | session ID value; |

| | |
|---|---|
| 2> | if the encoded RRC message is greater than the maximum supported size of one |
| | PDCP SDU specified in the relevant standard: |

| | |
|---|---|
| 3> | if the RRC message segmentation is enabled based on the field rrc-SegAllowed |
| | received in appLayerMeasConfig: |

| | |
|---|---|
| 4> | initiate the UL message segment transfer procedure as specified in clause 5.7.7; |

| | |
|---|---|
| 3> | else: |

| | |
|---|---|
| 4> | discard the RRC message; |

| | |
|---|---|
| 2> | else: |

| | |
|---|---|
| 3> | submit the MeasurementReportAppLayer message to lower layers for transmission |
| | upon which the procedure ends. |

That is, as shown in the application layer measurement reporting in FIG. 3B, the RRC reconfiguration is transmitted between the UE and the network in step 361, and the MeasurementReportAppLayer message is transmitted from the UE to the network in step 362.

Referring back to FIG. 3A, the NG-RAN 315 may transfer the measurement result report received from the UE to a final server (a trace collection entity (TCE) or a measurement collection entity (MCE)) 365 collecting the measurement report in step 370.

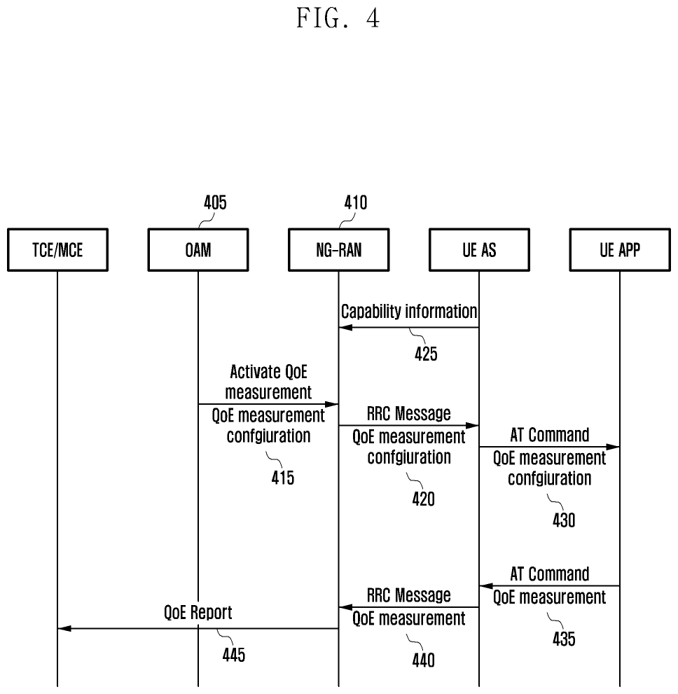

FIG. 4 illustrates a procedure of configuring/reporting management-based QoE measurement according to an embodiment.

A detailed description is omitted for steps that are the same as/similar to and steps among those performed during the management-based QoE configuration/report procedure that overlap the steps performed in the signaling-based QoE configuration/report procedure described in FIG. 3. The management-based QoE configuration/report procedure is described based on difference from the signaling-based procedure with reference to FIG. 4.

Referring to FIG. 4, in a scheme related to the management-based QoE configuration/report procedure, an OAM 405 may indicate activation of QoE measurement of the UE to the NG-RAN 410 by directly transmitting the QoE measurement configuration to the NG-RAN 410 without passing through a CN in step 415.

The NG-RAN 410 receiving the QoE measurement configuration may search for a single or a plurality of UEs that match at least one condition (for example, at least one of an area scope, an application layer capability, and a service type). The NG-RAN 410 may transmit/transfer the QoE measurement configuration to one of the single or plurality of UEs that has been found through an RRC message (for example, RRCReconfiguration message or RRCResume) in step 420.

Each UE receiving the RRC message may exchange the QoE measurement configuration and measurement result between the AS layer and the APP through the AT Command between the AS layer and the APP in steps 430 and 435, as described above in FIGS. 3A-3B. The AS layer of the UE may report the measurement result acquired from the APP to the NG-RAN 410 through the RRC message in step 440, and the NG-RAN 410 may transfer the measurement report to a TCE/MCE in step 445.

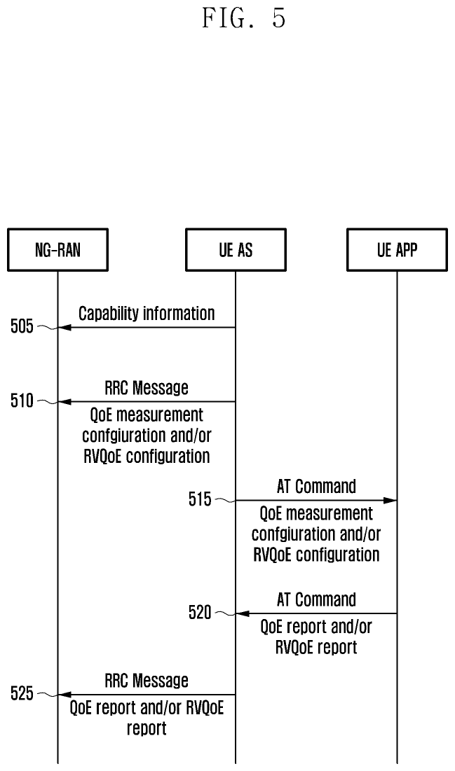

FIG. 5 illustrates a procedure of configuring and reporting RAN visible QoE measurement according to an embodiment.

In accordance with the scheme related to the signaling-based QoE configuration/report procedure and the measurement-based QoE configuration/report procedure described above in FIGS. 3 and 1D, respectively, the QoE measurement may be configured by the OAM, the QoE measurement report generated according to the corresponding configuration may be collected by the TCE/MCE, and the QoE measurement report may be used by an operator to optimize the network. The NG-RAN is unable to read or understand the OAM-based QoE measurement report transmitted by the UE. More specifically, in the MeasurementReportAppLayer message, the measurement report generated by the application layer of the UE is included in measurementReportAppLayerContainer but is stored in the form of OCTET STRING. Thus, the NG-RAN or the RRC layer of the NG-RAN is unable to read or understand the measurement report generated by the application layer of the UE. To enable the NG-RAN to read the QoE measurement report of the UE and use the same for optimizing the network such as radio resource management or the like, the 3GPP has defined and introduced RAN visible QoE (RVQoE) measurement.

Referring to FIG. 5, RVQoE measurement may be defined to be limited a specific service type (for example, streaming or VR). The UE may report whether RVQoE measurement is supported for each service type (for example, streaming or VR) to the NG-RAN in step 505. A UECapabilityInformation message may be used. For example, the UE may include or configure a ran-VisibleQoE-Streaming-MeasReport parameter within the UECapabilityInformation message and transmit the same to the NG-RAN for a streaming service, and may include or configure an ran-VisibleQoE-VR-MeasReport parameter within the UECapabilityInformation message and transmit the same to the NG-RAN for a VR service.

Based on whether the RVQoE measurement is supported for each service type (for example, streaming or VR) that the UE transmitted to the NG-RAN, the NG-RAN may determine whether the RVQoE measurement is supported for each service type by the UE, generate an RVQoE measurement configuration, based on the determination, and transmit the RVQoE measurement configuration to the UE in step 510. The RVQoE measurement configuration may be transferred along with the OAM-based QoE measurement configuration. The RVQoE measurement configuration may be included in the RRCReconfiguration or RRCResume message. The NG-RAN may indicate configuration or release of the RVQoE measurement through setup or release of the ran-VisibleParameters parameter within an AppLayerMeasConfig information element (IE).

The ran-VisibleParameters parameter may include the RAN-VisibleParameters IE, and some or all of the following parameters may be provided from the NG-RAN to the UE therethrough.

RVQoE measurement report period (ran-VisiblePeriodicity): the UE AS or the UE APP may transmit the RVQoE measurement report according to the period.

Maximum number of reportable buffer levels (numberOfBufferLevelEntries): the UE AS or the UE APP may include a plurality of buffer levels to report the RVQoE measurement, the number of buffer levels equal to or less than numberOfBufferLevelEntries may be included in the RVQoE measurement report.

Whether to report playout delay when media start reportPlayoutDelayForMediaStartup): when a value of reportPlayoutDelayForMediaStartup is indicated as true, the UE AS or the UE APP may include playout delay in the RVQoE report and transmit the same when media start. When the value of reportPlayoutDelayForMediaStartup is indicated as false, the UE may not include playout delay in the RVQoE report when media start.

The AS layer of the UE may transfer configuration information such as ran-VisiblePeriodicity described above to the APP layer of the UE in step 515. The RVQoE measurement configuration may be transferred to the APP layer along with the OAM-based QoE measurement configuration.

The APP of the UE may perform QoE measurement, based on the RVQoE measurement configuration information, generate the RVQoE measurement report, and transmit the measurement report to the AS layer of the UE in step 520. The RVQoE measurement report may be transferred to the AS layer along with the OAM-based QoE measurement report.

The AS layer of the UE receiving the RVQoE measurement report may transfer/transmit/report the received RVQoE measurement report to the NG-RAN in step 525.

The RVQoE measurement report may be transferred to the NG-RAN along with the OAM-based QoE measurement report. In step 525, the RVQoE measurement report may be transmitted through the RAN-VisibleMeasurements IE within the MeasurementReportAppLayer message, and the IE may include some or all of the following parameters.
Buffer level list of APP layer (appLayerBufferLevelList): the UE may include/report a plurality of buffer levels measured by the UE APP through the parameter. The included number may be limited by numberOfBufferLevelEntries in the RVQoE configuration.
Playout delay (playoutDelayForMediaStartup): the UE may include/report playout delay through the parameter and indicate the value in unit of ms when media start. When reportPlayoutDelayForMediaStartup is configured as true in the RVQoE configuration, the parameter may be included in the RVQoE measurement report.
PDU session ID list (pdu-SessionIdList): the UE may indicate PDU session(s) used for application data flow that is a target of the RVQoE measurement through the parameter. After receiving the RVQoE measurement report from the UE, the NG-RAN may detect what are the PDU session(s) for which the RVQoE values (for example, the buffer level and the playout delay) are measured through the parameter, allocate resources to the PDU sessions(s) indicated by the parameter according to the detection result, and optimize schedule.

The NG-RAN may read the RVQoE report and perform network optimization by using the same. For example, when it is determined that a specific UE is experiencing bad/poor QoE for a specific service, based on the RVQoE report, the NG-RAN may allocate the larger number of radio resources to the UE that is determined to be experiencing the bad/poor QoE, thereby improving the QoE of the UE that is determined to be experiencing the bad/poor QoE.

QoE configuration information (for example, 335 or 415) received by the NG-RAN may include area scope information (for example, AreaScope). The NG-RAN may identify, by using the corresponding information, the scope of an area in which the UE should perform QoE measurement in a connected mode state. For example, when the UE moves and escapes the corresponding area scope, the NG-RAN may release the QoE configuration and stop the QoE measurement of the UE.

The QoE configuration information (for example, 350 or 430) received by the UE application layer (terminal APP or UE APP) may include area scope information (for example, LocationFilter). The UE APP may identify the scope of an area in which the UE should perform QoE measurement by using the corresponding information. For example, when the UE APP moves and escapes the corresponding area scope, a new QoE measurement session may not start. However, the UE may continuously maintain the ongoing QoE measurement session (for example, unless a QoE configuration request is made to the NG-RAN).

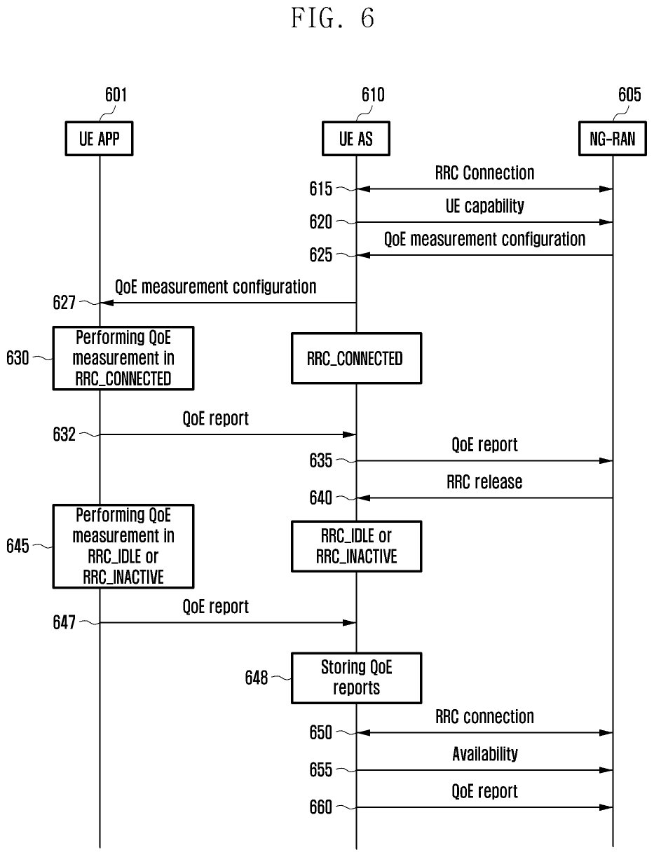

FIG. 6 illustrates a configuration and report procedure for supporting QoE measurement in inactive and idle modes as well as a connected mode of the UE according to an embodiment.

The 3GPP has standardized QoE measurement support in the connected mode in the relevant standard. By expanding the same, the 3GPP is standardizing a method of supporting QoE measurement not only in the connected mode (RRC_CONNECTED) but also in the inactive mode (RRC_INACTIVE) and the idle mode (RRC_IDLE) to support QoE measurement for a multicast broadcast service (MBS) service (or MBS) in the relevant standard, whereby the QoE configuration/measurement/report procedure between the UE and the NG-RAN not only in the connected mode (RRC_CONNECTED) but also in the inactive mode (RRC_INACTIVE) and the idle mode (RRC_IDLE) may be described below.

Referring to FIG. 6, in step 615, an NG-RAN 605 and a UE AS 610 may make (or establish) an RRC connection.

The NG-RAN may transmit a UE capability request message (for example, UECapabilityEnquiry) to the UE, and the UE receiving the same may transmit a UE capability message (for example, UECapabilityInformation) to the NG-RAN in step 620. The UE may transmit the UE capability message including a QoE measurement-related support capability indicator. For example, the UE may transmit whether QoE measurement for the MBS (for example, broadcast) service is supported to the NG-RAN, or whether QoE measurement not only in the connected mode (RRC_CONNECTED) but also the inactive mode (RRC_INACTIVE) and the idle mode (RRC_IDLE) is supported to the NG-RAN.

In steps 625 and 627, the NG-RAN 605 may provide the UE with QoE configuration information. For example, the QoE configuration information may include QoE measurement configuration information for the MBS (for example, broadcast) service, or configuration information for QoE measurement not only in the connected mode (RRC_CONNECTED) but also the inactive mode (RRC_INACTIVE) and the idle mode (RRC_IDLE).

In step 630, when the UE AS 610 is in the connected mode, the UE APP 601 may perform QoE measurement for the MBS service by using the QoE configuration information (for example, when the MBS service is received).

In step 632, the UE APP 601 may perform QoE measurement for the MBS service and transfer the measurement result or the measurement report to the UE AS 610 layer.

In step 635, the UE AS 610 may report the QoE measurement report received by the UE APP layer 601 to the NG-RAN 605. For example, when the UE is in the connected mode state and the NG-RAN configures an SRB (SRB4 or SRB5) for the QoE measurement report, the UE may immediately report the QoE measurement report to the NG-RAN.

In step 640, the NG-RAN may transmit an RRC release message to the UE, and the UE receiving the same may transition from the inactive mode to the idle mode. The UE may receive the MBS service even in the inactive or idle mode.

In step 645, the UE APP may perform QoE measurement for the MBS service by using the QoE configuration information received in step 625 while the AS receives the MBS service in the inactive mode or idle mode state.

In step 647, the UE APP may transfer the QoE measurement result or measurement report generated through the QoE measurement to the UE AS.

In step 648, since the UE AS is in the inactive or idle mode, the UE AS may store the QoE measurement report without immediately transmitting the same to the NG-RAN. For example, the UE APP may transfer the generated QoE measurement report to the UE AS, and the UE AS may store the report.

In step 650, the UE may make (or establish) an RRC connection with a (new) NG-RAN (RRC setup or RRC resume).

When the RRC connection is made in step 650, the UE may indicate, to the NG-RAN, that the UE stores the QoE measurement report (for example, measured in the inactive/idle mode) (for example, availability) through an RRCSetupComplete or RRCResumeComplete message in step 655.

In step 660, the NG-RAN receiving availability may allow the QoE measurement report of the UE by configuring the SRB (for example, SRB4 or SRB5) for transmitting the QoE measurement report to the UE, and the UE may perform the QoE measurement report.

To support QoE measurement for the MBS service or QoE measurement not only in the connected mode but also in the inactive/idle mode, a method of identifying area information is disclosed to prevent use of excessive energy/computing resources while the UE performs the QoE measurement even in areas in which the network (for example, the operator, the OAM, or the NG-RAN) is not interested in QoE measurement since QoE measurement can be performed as the UE moves not only in the connected mode but also the inactive/idle mode.

A first embodiment for supporting the QoE measurement for the MBS service and/or the QoE measurement not only in the connected mode but also in the inactive/idle mode is now described.

When the UE performs QoE measurement in the connected mode (for example, step 630), the NG-RAN may check area information of the UE by using AreaScope and, when the UE performs QoE measurement in the inactive or idle mode (for example, step 645), may check area information by using LocationFilter. When the UE is in the connected mode state, the NG-RAN may check area information by using AreaScope. When it is identified that the UE escapes AreaScope, the NG-RAN may release QoE measurement of the UE. On the other hand, when the UE is in the inactive or idle mode state, the NG-RAN may not be aware of the detailed location of the UE and may not transmit a message (for example, RRCReconfiguration) indicating release of the QoE measurement. Accordingly, when the UE is in the active or idle mode, the UE may check area information by itself and use LocationFilter therefor. When the UE moves outside the LocationFilter, the UE may not perform a new QoE measurement session.

The UE may perform the following procedure.
1) The UE may perform procedures of steps 615, 620, 625, and 627.
2) The UE APP may determine whether LocationFilter is configured within the QoE configuration information in step 627.
   2-1) If there is LocationFilter within the QoE configuration information,
      2-1-1) The UE may perform QoE measurement in the connected mode state but the UE APP may not check area information by using LocationFilter in the connected mode state in step 630. That is, the UE APP may perform or start QoE measurement regardless of the location. This is because the NG-RAN can check the area information by using AreaScope in the connected mode state. The UE in the connected mode state may report the QoE measurement report to the NG-RAN via the procedure of steps 632 and 635.
      2-1-2) The UE may transition to the inactive or idle mode as in step 640, and the UE AS may transfer the transitioned RRC state (inactive or idle mode) to the UE APP.
      2-1-3) The UE APP receiving the fact that the transition to the inactive or idle mode is made may perform QoE measurement in step 645 and start or active checking of area information using LocationFilter. This is because the NG-RAN may not perform checking of the area information using AreaScope in the inactive or idle mode.
      2-1-4) As an alternative to transmitting the RRC state in step 2-1-2, the UE AS may transfer an indicator (for example, indicator A) of activating checking of the area information using LocationFilter to the UE APP. The corresponding indicator may be defined/included in the AT Command, and when the UE AS includes the corresponding indicator or configure the same as “true” or “activate”, the UE APP may start or activate checking of the area information using Location Filter.
      2-1-5) The UE may check the area information using LocationFilter and perform QoE measurement in the inactive or idle mode.
      2-1-6) Thereafter, the UE may transition to the connected mode again, and the UE AS may transfer the fact that the transition to the connected mode is made to the UE APP.
      2-1-7) The UE APP receiving confirmation that the transition to the connected mode is made may stop or deactivate checking of the area information using LocationFilter. This is performed since the NG-RAN can check the area information using AreaScope in the connected mode.
      2-1-8) As an alternative to transmitting the fact that the transition to the connected mode is made in step 2-1-6, the UE AS may transfer an indicator (for example, indicator A) of deactivating checking of the area information using LocationFilter to the UE APP. The corresponding indicator may be defined/included in the AT Command, and when the UE AS omits the corresponding indicator or configures the same as “false” or “deactivate”, the UE APP may stop or deactivate checking of the area information using LocationFilter.
         The UE may perform QoE measurement while not checking the area information using LocationFilter in the connected mode.
   2-2) If there is no LocationFilter within QoE configuration information,
      2-2-1) The UE performs QoE measurement in the connected mode state but the UE APP cannot check area information using LocationFilter in the connected mode state in step 630 (because LocationFilter does not exist). That is, the UE APP may perform or start QoE measurement regardless of the location. This is performed since the NG-RAN can check the area information using AreaScope in the connected mode state.
      2-2-2) The UE may transition to the inactive or idle mode and the UE AS may transfer confirmation to the UE APP as in step 640.
      2-2-3) The UE APP receiving the confirmation that the transition to the inactive or idle mode is made may perform QoE measurement and stop or deactivate the QoE measurement in step 645. This is because that the NG-RAN may not check the area information using AreaScope in the inactive or idle mode and the UE APP may not check the area information since the UE APP also does not have LocationFilter. It may not be preferable to perform QoE measurement when both the UE and the NG-RAN cannot check the area information, since the UE may maintain the inactive or idle mode for a long time period (e.g., a time period longer than a threshold) in which the UE may move and waste energy/computing resources to perform QoE measurement even in areas (for example, areas beyond AreaScope) in which the network (for example, an operator, OAM, or the NG-RAN) is not interested in QoE measurement.
      2-2-4) As an alternative to transferring confirmation that the transition to the inactive or idle mode is made in step 2-2-3, the UE AS may transfer an indicator (for example, indicator B) of stopping or deactivating QoE measurement to the UE APP. The corresponding indicator may be defined/included in the AT Command. When the UE AS includes the corresponding indicator or configures the same as “true”, “stop”, or “deactivate”, the UE APP may stop or deactivate QoE measurement.
      2-2-5) Thereafter, the UE may re-transition to the connected mode, and the UE AS may transfer confirmation to the UE APP.
      2-2-6) The UE APP receiving confirmation that the transition to the connected mode is made may start, resume, or activate QoE measurement, since the NG-RAN can check area information using AreaScope in the connected mode.
      2-2-7) As an alternative to step 2-1-6, the UE AS may transfer an indicator (for example, indicator B) of starting, resuming, or activating QoE measurement in the UE APP to the UE APP. The corresponding indicator may be defined/included in the AT Command. When the UE AS omits the corresponding indicator or configures the same as “false”, “start”, or “activate”, the UE APP may start, resume, or activate QoE measurement.

In the above embodiment, if there is no LocationFilter within the QoE configuration information, the UE may stop QoE measurement. Accordingly, to prevent stopping of the QoE measurement and support continuous QoE measurement, requirements indicating that LocationFilter should be always included within the QoE configuration information may be defined if the QoE configuration is a configuration for the MBS service or a configuration for QoE measurement not only in the connected mode but also in the inactive/idle mode. When the QoE configuration is the QoE configuration for the MBS service and/or is the QoE configuration for the connected mode and the inactive mode/idle mode, the QoE configuration may include LocationFilter. In this case, when the OAM generates QoE configuration information, LocationFilter may be always included within the QoE configuration if the QoE configuration to be generated is the configuration for the MBS service or the configuration for QoE measurement not only in the connected mode but also in the inactive/idle mode.

A second embodiment for supporting the QoE measurement for the MBS service or the QoE measurement not only in the connected mode but also in the inactive/idle mode is now described.

When the UE performs QoE measurement in the connected mode, the NG-RAN may check area information of the UE by using AreaScope and, when the UE performs QoE measurement in the inactive or idle mode, a new AS layer area information configuration (for example, AS_AreaScope) may be introduced therefor and the UE AS layer may check area information by using AS_AreaScope. When the UE is in the connected mode state, the NG-RAN may check area information by using AreaScope. When it is identified that the UE escapes AreaScope, the NG-RAN may release QoE measurement of the UE. On the other hand, when the UE is in the inactive or idle mode state, the NG-RAN may not be aware of the detailed location of the UE and may transmit a message (for example, RRCReconfiguration) indicating release of the QoE measurement. Accordingly, when the UE is in the inactive or idle mode, the UE may check area information, and a new AS layer area information configuration (for example, AS_AreaScope) may be defined/introduced and used therefor. For example, the UE APP may perform QoE measurement and transfer a measurement result or a measurement report to the UE AS. If the location of the UE is within AS_AreaScope when the UE AS receives the measurement report from the UE APP, the UE AS stores the received QoE measurement result. Otherwise (that is, the location of the UE is outside AS_AreaScope), the UE AS may discard and not store the received QoE measurement result.

For example, the UE may perform the following procedure.
1) The UE may perform procedures of steps 615, 620, 625, and 627.
2) The UE AS may receive area information (for example, AS_AreaScope) of the AS layer through QoE configuration information in step 625. This may be information that the OAM or the NG-RAN generates and transfers to the UE AS. The UE AS may use and not transfer AS_AreaScope to the UE APP.
3) The UE may perform QoE measurement in the connected mode state in step 630, but the UE AS may not check area information using AS_AreaScope in the connected mode. That is, the UE AS in the connected mode state may store the QoE report received from the UE APP regardless of the location since the NG-RAN can check the area information using AreaScope in the connected mode state.
4) The UE may transition to the inactive or idle mode as in step 640.
5) The UE may perform QoE measurement in the inactive or idle mode in step 645, in which case the UE AS may check area information using AS_AreaScope, since the NG-RAN may not check the area information using AreaScope in the inactive or idle mode. That is, if the location of the UE is within AS_AreaScope when the UE AS receives the measurement report from the UE APP, the UE AS in the inactive or idle mode state store the received QoE measurement result. Otherwise (that is, the location of the UE is outside AS_AreaScope), the UE AS may discard and not store the received QoE measurement result.

A third embodiment for supporting the QoE measurement for the MBS service or the QoE measurement not only in the connected mode but also in the inactive/idle mode is now described.

The OAM may select/configure one of the two configuration methods.

As a first configuration method (for example, Mode 1), the OAM may not configure checking of area information using AreaScope by the NG-RAN. In this case, the UE APP may check area information based on LocationFilter regardless of the RRC mode.

As a second configuration method (for example, Mode 2), the OAM may configure checking of area information using AreaScope by the NG-RAN. In this case, the UE APP may check area information using LocationFilter in the inactive or idle mode, and the NG-RAN may check area information using AreaScope when the UE is in the connected mode state. That is, when the OAM configures the second mode (Mode 2), the UE and the NG-RAN may perform the operation according to the first embodiment (for supporting the QoE measurement for the MBS service or the QoE measurement not only in the connected mode but also in the inactive/idle mode).

For example, the UE/OEM/NG-RAN may perform the following procedure.
1) The OAM may transmit configuration information on QoE measurement for the MBS service or QoE measurement not only in the connected mode but also in the inactive/idle mode to the NG-RAN. The OAM may include a Mode indicator as well as LocationFilter in the QoE configuration information. If the OAM configures the Mode indicator as “Mode 1”, the OAM may not configure checking of the area information using AreaScope by the NG-RAN. That is, the OAM may transmit the QoE configuration that does not include AreaScope to the NG-RAN. If the OAM configures the Mode indicator as “Mode 2”, the OAM may configure checking of the area information using AreaScope by the NG-RAN. That is, the OAM may transmit the QoE configuration including AreaScope to the NG-RAN.
2) The NG-RAN may receive the QoE configuration information and, when Mode 1 is configured, may not configure/received AreaScope. When Mode 2 is configured, the NG-RAN may configure/receive AreaScope. When the UE is in the connected mode state, check area information based on AreaScope.
   The Mode indicator is information that can be read by the UE APP but cannot be read by the NG-RAN (for example, the Mode indicator is contained/included in the RRC container). However, the NG-RAN may check the area information based on AreaScope through whether AreaScope is configured/received.
   The NG-RAN may read the Mode indicator. In this case, when the NG-RAN receives Mode 1, the NG-RAN may not check the area information based on AreaScope even though AreaScope is received from the OAM. That is, the NG-RAN may check the area information based on AreaScope only when Mode 2 is received and AreaScope is received from the OAM.
3) The NG-RAN may transmit QoE configuration information including LocationFilter and the Mode indicator to the UE AS in step 340 or 420. The information may be contained/included in the RRC container (for example, measConfigAppLayerContainer) and transmitted.
4) The UE AS may transfer QoE configuration information including LocationFilter and the Mode indicator to the UE APP. The UE AS may transmit the received RRC container (for example, measConfigAppLayerContainer) to the UE APP.
5) When receiving an indication of “Mode 1” through the Mode indicator, the UE APP may check area information based on LocationFilter regardless of the RRC mode. Conversely, when receiving an indication of “Mode 2” through the Mode indicator, the UE APP may check area information based on LocationFilter only in the inactive or idle mode. This is performed since, when the UE is in the connected mode, the OAM provides AreaScope to the NG-RAN so that the NG-RAN can check area information using AreaScope.

The OAM may indicate an RRC mode in which the area information can be checked using LocationFilter instead of the Mode indicator in the QoE configuration information. That is, instead of indicating the Mode indicator as Mode 1, the RRC mode to which LocationFilter can be applied may be indicated as “all RRC states”. Instead of indicating the Mode indicator as Mode 2, the RRC mode to which LocationFilter can be applied may be indicated as “RRC_IDLE & RRC_INACTVE”.

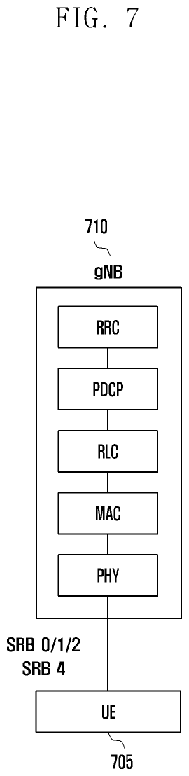

FIG. 7 illustrates an SRB path in an SA situation according to an embodiment.

Referring to FIG. 7, the UE may be connected to the network in a standalone (SA) state. That is, a UE 705 may communicate with a gNB 710. Between the gNB and the UE, an SRB may be defined/used/configured to transmit an RRC message or a non-access stratum (NAS) message. In the SA state, SRB0, SRB1, SRB2, and SRB4 may be configured/used. SRB4 may be used to transmit a QoE measurement report message (or an App layer measurement report message) of the UE.

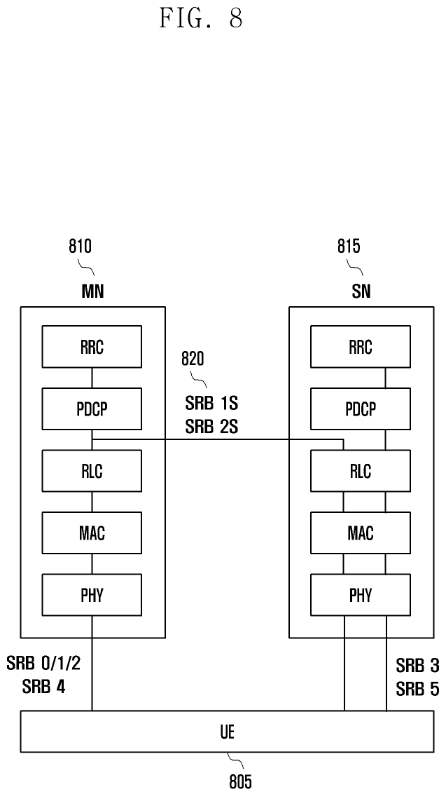

FIG. 8 illustrates an SRB path in a DC situation according to an embodiment.

Referring to FIG. 8, the UE may be connected to the network in a dual connectivity (DC) (for example, NR-NR dual connectivity (NR-DC)) state. That is, a UE 805 may simultaneously communicate with two BSs in a state where a connection with each of the two BSs 810 and 815 is configured. The respective BSs may be referred to as a master node (MN) 810 and a secondary node (SN) 815. Between the BS and the UE, an SRB may be defined/used to transmit an RRC message or an NAS message. SRB0, SRB1, SRB2, and SRB4 may be configured/used for communication between the UE and the MN. SRB4 may be used to transmit a QoE measurement report message (or an App layer measurement report message) of the UE. Among them, SRB1 and SRB2 may be configured split SRBs 820, and the split SRB may support communication between the UE and the MN via an RRC/packet data convergence protocol (PDCP) layer of the MN and a radio link control (RLC)/medium access control (MAC)/PHY layer of the SN. The BS may configure an SRB path for communication with the UE by using the split SRB. For example, the BS may configure whether to use the RLC/MAC/PHY layer of the MN, the RLC/MAC/PHY layer of the SN, or both. If the RLC/MAC/PHY layers of the MN and the SN are all used (duplication), reliability of transmission may increase through overlapping transmission of the packet. SRB3 and SRB5 may be configured/used for communication between the UE and the SN.

The UE may need to configure the SRB with the SN as well as the MN to transmit the QoE measurement report message. The UE may use SRB4 to transmit the QoE measurement report message to the MN (RRC layer of the MN). Alternatively, the UE may define/use split SRB4 to transmit the QoE measurement report message to the MN (RRC layer of the MN). In this case, the QoE measurement report message may be transferred to the PDCP/RRC layer of the MN via the PHY/MAC/RLC layer of the SN. Alternatively, the UE may use SRB3 to transmit the QoE measurement report message to the SN (RRC layer of the SN). The QoE measurement report message may have a lower priority than the RRC message conventionally transmitted to SRB3, since the QoE report is used for optimizing the network operation but is not necessary for the network operation. Accordingly, to transmit the QoE measurement report message to the SN (RRC layer of the SN), a new SRB (for example, SRB5 having a lower priority than SRB3) may be defined/used. Like SRB3, SRB5 may make a connection with the RRC layer of the SN via the PHY/MAC/RLC/PDCP layer of the SN.

To receive QoE configuration information from the MN (RRC layer of the MN), the UE may receive a configuration of SRB1 (or split SRB1) and use the SRB1 configuration. To receive QoE configuration information from the SN (RRC layer of the SN), the UE may receive and use a configuration of SRB3. Alternatively, the UE may receive QoE configuration information in the form in which the SRB1 message includes the SN message (including SN QoE configuration information).

The UE in the NR-DC state may receive, from the network, an indication for a reporting leg (for example, whether to transmit the QoE measurement report to the MN or the SN or whether to use SRB4 or SRB5) that should be used for the QoE measurement report. The UE may transmit the QoE measurement report to the BS by using the indicated reporting leg.

The UE in the NR-DC state may receive, from the network, an indication for a reporting leg (for example, whether to transmit the QoE measurement report to the MN or the SN or whether to use SRB4 or SRB5) that should be used for the RAN visible QoE (RVQoE) measurement report. This may be indicated separately from the reporting leg of the QoE rather than RVQoE. Since the configuration and report of QoE rather than RVQoE are contained/included in a container and thus are not shown within the RRC layer, the QoE rather than the RVQoE may be referred to as encapsulated QoE. That is, the UE may separately receive a configuration of the reporting leg for the measurement report on the encapsulated QoE and the reporting leg for the measurement report on the RVQoE from the network. The network may indicate identical or different values for the reporting leg for the measurement report on the encapsulated QoE and the reporting leg for the measurement report on the RVQoE. The UE may transmit the RVQoE measurement report to the BS by using the indicated reporting leg for RVQoE.

The disclosure is made based on the assumption of NR-DC, but the same method may be applied to various types of DC situations (for example, multi-radio access technology (RAT) (MR-DC)).

The MN or a master cell group (MCG) may transmit a QoE configuration to the UE through SRB1, and the SN or a secondary cell group (SCG) may transmit a QoE configuration to the UE through SRB3.

The MN or the MCG may transfer the QoE configuration (for example, in the form of an encapsulated message) to the SN or the SCG, and the SN or the SCG may configure the QoE configuration in the UE through SRB3.

The SN or the SCG may transfer the QoE configuration (for example, in the form of an encapsulated message) to the MN or the MCG, and the MN or the MCG may configure the QoE configuration in the UE through SRB1.

The UE may transmit the QoE measurement report to the MN or the MCG through SRB4 and transmit the QoE measurement report to the SN or the SCG through SRB5.

The UE may transmit the QoE measurement report to the MN or the MCG through SRB4, and the MN or the MCG receiving the measurement report may transmit the same to the TCE or the MCE (via the CN).

The UE may transmit the QoE measurement report to the MN or the MCG through SRB4, and the MN or the MCG receiving the measurement report may transmit the same to the SN or the SCG (for example, in the form of an encapsulated message).

The UE may transmit the QoE measurement report to the SN or the SCG through SRB5, and the SN or the SCG receiving the measurement report may transmit the same to the TCE or the MCE (via the CN).

The UE may transmit the QoE measurement report to the SN or the SCG through SRB5, and the SN or the SCG receiving the measurement report may transmit the same to the MN or the MCG (for example, in the form of an encapsulated message).

Although the UE receives an indication of the reporting leg for the encapsulated QoE from the network, when an SRB corresponding thereto is not available (for example, when no configuration is made by the network, when the corresponding MN (or MCG) or SN (or SCG) is deactivated, or in the case of failure or recovery), the UE may may not transmit the encapsulated QoE measurement report and the UE may store the encapsulated QoE measurement report. The UE may store the corresponding encapsulated QoE measurement report until the corresponding SRB becomes available again or the corresponding QoE configuration is released, and thereafter, may delete the measurement report. When the corresponding SRB becomes available again, the UE may report the stored encapsulated QoE measurement report to the BS and delete the stored encapsulated QoE measurement report. Alternatively, when the corresponding QoE configuration is released, the UE may delete the stored encapsulated QoE measurement report without reporting the measurement report the stored encapsulated QoE measurement report to the BS.

Although the UE receives an indication of the reporting leg for the RAN visible QoE (RVQoE) from the network, when an SRB corresponding thereto is not available (for example, when no configuration is made by the network, when the corresponding MN (or MCG) or SN (or SCG) is deactivated, or in the case of failure or recovery), the UE may store the RVQoE measurement report without transmitting the RVQoE measurement report The UE may store the corresponding RVQoE measurement report until the corresponding SRB becomes available again or the corresponding QoE configuration is released, and may then delete the measurement report. When the corresponding SRB becomes available again, the UE may report the stored RVQoE measurement report to the BS and delete the stored RVQoE measurement report. Alternatively, when the corresponding QoE configuration is released, the UE may delete the stored RVQoE measurement report without reporting the measurement report the stored RVQoE measurement report to the BS.

Although the UE receives an indication of the reporting leg for the RAN visible QoE (RVQoE) from the network, when an SRB corresponding thereto is not available (for example, when no configuration is made by the network, when the corresponding MN (or MCG) or SN (or SCG) is deactivated, or in the case of failure or recovery), the UE may not transmit the RVQoE measurement report and the UE may discard the RVQoE measurement report.

To the BS, the RVQoE measurement report may be data required in real time for managing and optimizing the network. That is, since the encapsulated measurement report may be reported for a relatively long time period (e.g., longer than a time period for RVQoE measurement report) and may be collected and used even by the TCE/MCE via many entities (for example, the UE, the BS, the CN, and the TCE/MCE), a relatively long time delay (e.g., longer than a threshold) may ensue from QoE report generation (by the UE) to QoE report collection (by the TCE/MCE), based on which a network operator (the OAM or the TCE/MCE) may perform network optimization. On the other hand, the RVQoE measurement report is reported according to a short time period (for example, within 1 second) and reporting is performed between the UE and the BS. Thus, a relatively short delay time is generated from QoE report generation (by the UE) to QoE report collection (by the BS). Accordingly, the BS may use the corresponding QoE measurement report for (real time) network optimization in a short time.

For this reason, when the UE cannot use the corresponding SRB, even if the UE stores the RVQoE measurement report and then sends confirmation to the BS, the RVQoE measurement report may be already outdated data for the BS and unusable data that cannot be used for real time network optimization. Accordingly, the UE may discard the corresponding RVQoE measurement report to prevent excessive use of resources (for example, the use of the UE memory for storing the RVQoE measurement report that is no longer useful and the use of radio resources for transmission) according to storage or transmission of the RVQoE report.

When the reporting leg for the RAN visible QoE (RVQoE) is configured, requirements indicating that the BS should always configure a corresponding SRB in the UE may be defined in the relevant standard since the UE may not additionally perform the operation of storing or discarding the invalid RVQoE measurement report.

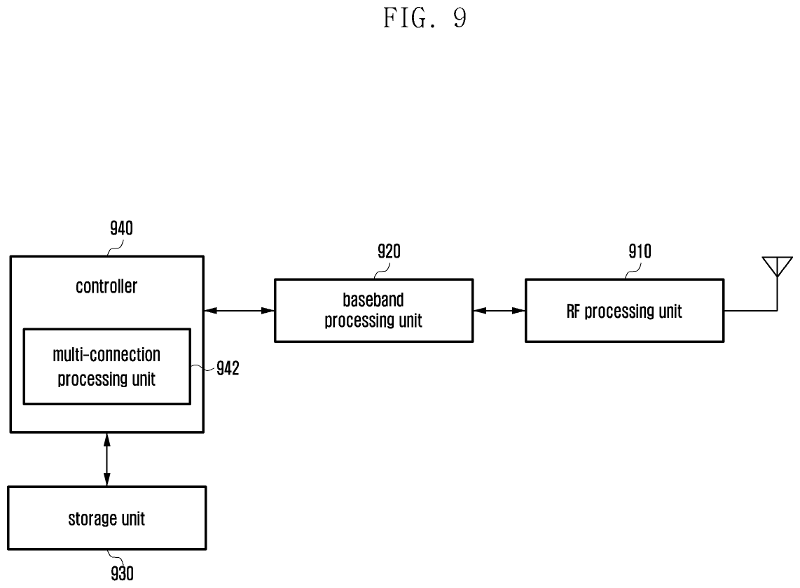

FIG. 9 illustrates the internal structure of the UE to which the disclosure is applied.

Referring to FIG. 9, the UE includes a radio frequency (RF) processing unit 910, a baseband processing unit 920, a storage unit 930, and a controller 940.

The RF processing unit 910 performs a function for transmitting and receiving a signal through a wireless channel, such as band conversion and amplification of a signal. That is, the RF processing unit 910 up-converts a baseband signal provided from the baseband processing unit 920 into an RF band signal, transmits the RF band signal through an antenna, and then down-converts the RF band signal received through the antenna into a baseband signal. For example, the RF processing unit 910 may include a transmission filter, a reception filter, an amplifier, a mixer, an oscillator, a digital-to-analog converter (DAC), an analog-to-digital converter (ADC), and the like. Although only one antenna is illustrated in the drawing, the UE may include a plurality of antennas. The RF processing unit 910 may include a plurality of RF chains. Moreover, the RF processing unit 910 may perform beamforming. For the beamforming, the RF processing unit 910 may control a phase and a size of each signal transmitted/received through a plurality of antennas or antenna elements. The RF processing unit may perform MIMO and receive a plurality of layers when performing the MIMO operation.

The baseband processing unit 920 performs a function for a conversion between a baseband signal and a bitstream according to a physical layer standard of the system. For example, when data is transmitted, the baseband processing unit 920 generates complex symbols by encoding and modulating a transmission bitstream. In data reception, the baseband processing unit 920 reconstructs a reception bitstream by demodulating and decoding a baseband signal provided from the RF processing unit 910. For example, in an orthogonal frequency division multiplexing (OFDM) scheme, when data is transmitted, the baseband processing unit 920 generates complex symbols by encoding and modulating a transmission bitstream, maps the complex symbols to subcarriers, and then configures OFDM symbols through an inverse fast Fourier transform (IFFT) operation and a cyclic prefix (CP) insertion. When data is received, the baseband processing unit 920 divides the baseband signal provided from the RF processing unit 910 in the unit of OFDM symbols, reconstructs the signals mapped to the subcarriers through a fast Fourier transform (FFT) operation, and then reconstructs a reception bitstream through demodulation and decoding.

The baseband processing unit 920 and the RF processing unit 910 transmit and receive signals as described above. Accordingly, each of the baseband processing unit 920 and the RF processing unit 910 may be referred to as a transmitter, a receiver, a transceiver, or a communication unit. At least one of the baseband processing unit 920 and the RF processing unit 910 may include a plurality of communication modules for supporting a plurality of different radio access technologies. At least one of the baseband processing unit 920 and the RF processing unit 910 may include different communication modules for processing signals in different frequency bands. For example, the different radio access technologies may include a wireless LAN (for example, institute of electrical and electronics engineers (IEEE) 802.11) and a cellular network (for example, LTE). The different frequency bands may include a super high frequency (SHF) (for example, 2.NRHz, NRHz) band and a millimeter (mm) wave (for example, 60 GHz) band.

The storage unit 930 stores data such as a basic program for the operation of the UE, an application, configuration information, and the like. Particularly, the storage unit 930 may store information related to a second access node that performs wireless communication by using the radio access technology. The storage unit 930 provides data stored therein according to a request from the controller 940.

The controller 940 controls the overall operation of the UE. For example, the controller 940 transmits and receives signals through the baseband processing unit 920 and the RF processing unit 910. The controller 940 may record data in the storage unit 930 and read the data. To this end, the controller 940 may include at least one processor. For example, the controller 940 may include a communications processor (CP) that performs control for communication, and an application processor that controls higher layers such as an application layer and may include a multi-connection processing unit 942.

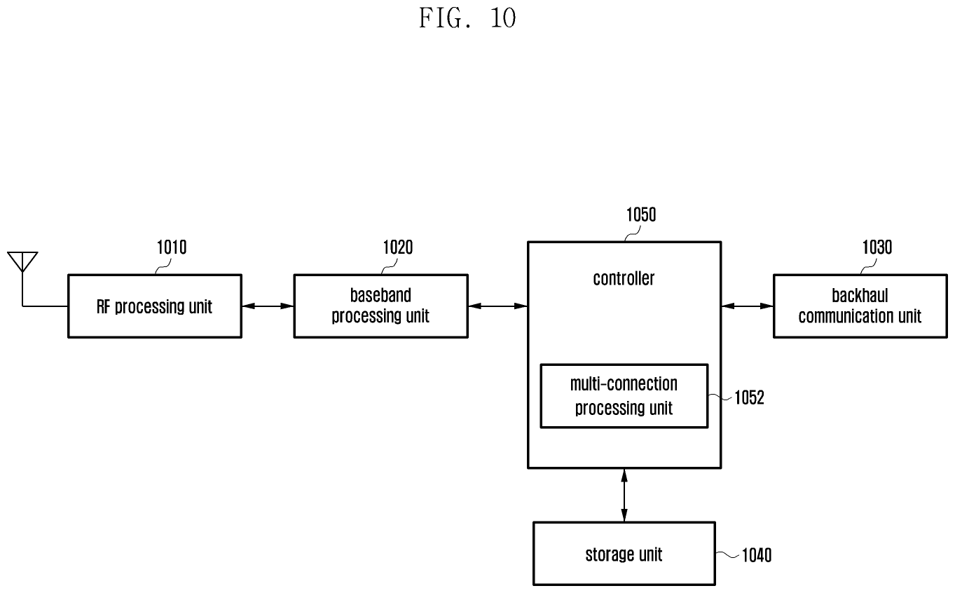

FIG. 10 illustrates the structure of the BS to which the disclosure is applied.

Referring to FIG. 10, the BS is constituted to include an RF processing unit 1010, a baseband processing unit 1020, a backhaul communication unit 1030, a storage unit 1040, and a controller 1050.

The RF processing unit 1010 performs a function for transmitting and receiving a signal through a wireless channel, such as band conversion and amplification of a signal. That is, the RF processing unit 1010 up-converts a baseband signal provided from the baseband processing unit 1020 into an RF band signal, transmits the RF band signal through an antenna, and then down-converts the RF band signal received through the antenna into a baseband signal. For example, the RF processing unit 1010 may include a transmission filter, a reception filter, an amplifier, a mixer, an oscillator, a DAC, an ADC, and the like. Although only one antenna is illustrated in the drawing, the BS may include a plurality of antennas. The RF processing unit 1010 may include a plurality of RF chains. The RF processing unit 1010 may perform beamforming. For the beamforming, the RF processing unit 1010 may control the phase and the size of each of the signals transmitted and received through a plurality of antennas or antenna elements. The RF processing unit may perform a downlink MIMO operation by transmitting one or more layers.

The baseband processing unit 1020 performs a function of performing conversion between a baseband signal and a bitstream according to a physical layer standard of the radio access technology. For example, when data is transmitted, the baseband processing unit 1020 generates complex symbols by encoding and modulating a transmission bitstream. When data is received, the baseband processing unit 1020 reconstructs a reception bitstream by demodulating and decoding a baseband signal provided from the RF processing unit 1010. For example, in an OFDM scheme, when data is transmitted, the baseband processing unit 1020 may generate complex symbols by encoding and modulating the transmission bitstream, map the complex symbols to subcarriers, and then configure OFDM symbols through an IFFT operation and CP insertion. In addition, when data is received, the baseband processing unit 1020 divides a baseband signal provided from the RF processor 1010 in units of OFDM symbols, recovers signals mapped with sub-carriers through an FFT operation, and then recovers a reception bitstream through demodulation and decoding. The baseband processing unit 1020 and the RF processing unit 1010 transmit and receive signals as described above. Accordingly, each of the baseband processing unit 1020 and the RF processing unit 1010 may be referred to as a transmitter, a receiver, a transceiver, a communication unit, or a wireless communication unit.

The backhaul communication unit 1030 provides an interface for communicating with other nodes within the network. That is, the backhaul communication unit 1030 converts a bitstream transmitted to the secondary BS or a core network from the main BS, into a physical signal and converts a physical signal received from the other node into the bitstream.

The storage unit 1040 stores data such as a basic program, an application, and setting information for the operation of the main BS. Particularly, the storage unit 1040 may store information on bearers allocated to the accessed UE and the measurement result reported from the accessed UE. The storage unit 1040 may store information on a reference for determining whether to provide multiple connections to the UE or stop the multiple connections. The storage unit 1040 provides data stored therein according to a request from the controller 1050.

The controller 1050 controls the overall operation of the main BS. For example, the controller 1050 transmits and receives a signal through the baseband processing unit 1020 and the RF processing unit 1010 or through the backhaul communication unit 1030. The controller 1050 may record data in the storage unit 1040 and read the data. To this end, the controller 1050 may include at least one processor and may include a multi-connection processing unit 1052.

Parts of an embodiment and another embodiment of the disclosure may be combined and operated by the BS and the UE. Embodiments of the disclosure also can be applied to other communication systems, and other modifications based on the technical spirit of the embodiments also can be achieved. For example, embodiments may be applied to LTE systems, 5G, NR systems, 6G systems, or the like. Therefore, the scope of the disclosure should not be defined as being limited to the above embodiments.

It may be understood that each block of the flowchart illustrations and combinations of the flowchart illustrations can be implemented by computer program instructions. These computer program instructions may be loaded onto a general-purpose computer, special-purpose computer, or processor of other programmable data-processing equipment, such that the instructions which execute on the computer or the processor of other programmable data-processing equipment generate a means for performing the functions specified in the flowchart block(s). Since these computer program instructions can also be stored in a computer-available or computer-readable memory that can direct a computer or other programmable data processing equipment to be implemented in a particular manner, the instructions stored in the computer-available or computer-readable memory can generate manufactured items including an instruction means which performs the functions specified in the flowchart block(s). Since the computer program instructions can also be loaded onto a computer or other programmable data-processing equipment, the instructions executed on the computer or other programmable data-processing equipment by performing a series of operational steps on the computer or other programmable data-processing equipment to produce a computer-implemented process can provide steps for implementing the functions specified in the flowchart block(s).

Each block may represent a portion of a module, a segment, or a code, which includes one or more executable instructions for implementing the specified logical function(s). It should also be noted that, in some alternative implementation examples, the functions mentioned in the blocks may occur in a different order. For example, two successive blocks may be simultaneously performed substantially or may be performed in a reverse order according to the corresponding functions sometimes.

The term ˜er (or unit) used herein refers to software or a hardware component such as an FPGA or an ASIC and plays any role. However, the ˜er (or unit) is not limited to software or hardware. The ˜er (or unit) may be constituted in a storage medium capable of addressing and constituted to reproduce one or more processors. Accordingly, the ˜er (or unit) includes software components, object-oriented software components, components such as class components and task components, processors, functions, attributes, procedures, subroutines, segments of program code, drivers, firmware, microcode, a circuit, data, a database, data structures, tables, arrays, and parameters. Functions provided in the elements and the ˜ers (or units) may be combined into fewer elements and the ˜ers (or units) or divided into more elements and ˜ers (or units). The elements and the ˜ers (or units) may be implemented to reproduce one or more central processing units (CPUs) in a device or secure multimedia card.

Herein, diagrams of a control/data signal transmission method, operating procedures, and configurations are not intended to limit the scope of the disclosure. In other words, all components, entities, or operation steps described herein should not be construed as being essential elements for implementation of the disclosure, and the disclosure may be implemented by including only some elements without departing the essence of the disclosure. Furthermore, respective embodiments may be combined with each other for operation as necessary. For example, parts of the methods in the disclosure may be combined with each other to operate a network entity and a UE.

The above-described operations of the BS or the UE may be performed when an arbitrary component within the BS or the UE apparatus includes a memory device storing the corresponding program code. That is, a controller of the BS or the UE apparatus may perform the above-described operations by reading and executing the program code stored in the memory device through a processor or a CPU.

Entities, various elements of the BS or UE apparatus, modules, and the like used in the disclosure may operate by using a hardware circuit, a combination of a complementary metal oxide semiconductor-based logical circuit, firmware, software and/or hardware, and a combination of firmware and/or software inserted into a machine-readable medium. For example, various electrical structures and methods may be realized using transistors, logic gates, and electrical circuits such as application specific integrated circuit.

In the implementation of software, a computer-readable storage medium for storing one or more programs (software modules) may be provided. The one or more programs stored in the computer-readable storage medium may be configured for execution by one or more processors within the electronic device. The one or more programs may include instructions for enabling the electronic device to perform methods according to embodiments of the disclosure.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, the programs may be stored in a memory configured by a combination of some or all of the listed components. The number of configured memories may be plural.

The programs may be stored in an attachable storage device which may access through communication networks such as the Internet, an Intranet, a local area network (LAN), wireless LAN (WLAN), and a storage area network (SAN) or a combination thereof. The storage device may access the device that implements embodiments of the disclosure through an external port. A separate storage device in the network may access the device that implements embodiments of the disclosure.

The embodiments herein may be combined and operated as necessary. Although the embodiments are presented based on 5G and NR systems, other modification examples based on the technical spirit of the embodiments may be applied to other systems such as LTE, LTE-A, and LTE-A-Pro systems, and the like.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a user equipment (UE) in a communication system, the method comprising:
receiving, via radio resource control (RRC) signaling, an application layer measurement configuration;
obtaining radio access network (RAN) visible application layer measurement reports after receiving the application layer measurement configuration;
identifying whether a first signaling radio bearer (SRB) for transmission of the RAN visible application layer measurement reports is available; and
discarding the RAN visible application layer measurement reports in case that the first SRB for the transmission of the RAN visible application layer measurement reports is not available.

2. The method of claim 1,
wherein the application layer measurement configuration includes a first configuration of the first SRB for the transmission of the RAN visible application layer measurement reports, and
wherein the first configuration indicates one of an SRB4 or an SRB5.

3. The method of claim 1, further comprising:
transmitting the RAN visible application layer measurement reports based on the first SRB for the transmission of the RAN visible application layer measurement reports in case that the first SRB for the transmission of the RAN visible application layer measurement reports is available.

4. The method of claim 1, further comprising:
obtaining encapsulated application layer measurement reports after reception of the application layer measurement configuration;
identifying whether a second SRB for transmission of the encapsulated application layer measurement reports is available; and
storing the encapsulated application layer measurement reports until the second SRB for the transmission of the encapsulated application layer measurement reports is available in case that the second SRB for the transmission of the encapsulated application layer measurement reports is not available.

5. The method of claim 4,
wherein the application layer measurement configuration includes a second configuration of the second SRB for the transmission of the encapsulated application layer measurement reports, and
wherein the second configuration indicates one of an SRB4 or an SRB5.

6. The method of claim 4,
wherein a first period for the RAN visible application layer measurement reports is shorter than a second period for the encapsulated application layer measurement reports.

7. A user equipment (UE) in a communication system, the UE comprising:
a transceiver; and
a processor coupled with the transceiver and configured to:
receive, via radio resource control (RRC) signaling, an application layer measurement configuration,
obtain radio access network (RAN) visible application layer measurement reports after receiving the application layer measurement configuration,
identify whether a first signaling radio bearer (SRB) for transmission of the RAN visible application layer measurement reports is available, and
discard the RAN visible application layer measurement reports in case that the first SRB for the transmission of the RAN visible application layer measurement reports is not available.

8. The UE of claim 7,
wherein the application layer measurement configuration includes a first configuration of the first SRB for the transmission of the RAN visible application layer measurement reports, and
wherein the first configuration indicates one of an SRB4 or an SRB5.

9. The UE of claim 7,
wherein the processor is further configured to transmit the RAN visible application layer measurement reports based on the first SRB for the transmission of the RAN visible application layer measurement reports in case that the first SRB for the transmission of the RAN visible application layer measurement reports is available.

10. The UE of claim 7, wherein the processor is further configured to:
obtain encapsulated application layer measurement reports after reception of the application layer measurement configuration,
identify whether a second SRB for transmission of the encapsulated application layer measurement reports is available, and
store the encapsulated application layer measurement reports until the second SRB for the transmission of the encapsulated application layer measurement reports is available in case that the second SRB for the transmission of the encapsulated application layer measurement reports is not available.

11. The UE of claim 10,
wherein the application layer measurement configuration includes a second configuration of the second SRB for the transmission of the encapsulated application layer measurement reports, and
wherein the second configuration indicates one of an SRB4 or an SRB5.

12. The UE of claim 10,
wherein a first period for the RAN visible application layer measurement reports is shorter than a second period for the encapsulated application layer measurement reports.

13. A method performed by a base station in a communication system, the method comprising:
transmitting a first radio resource control (RRC) message including an application layer measurement configuration;
receiving a second RRC message including radio access network (RAN) visible application layer measurement reports after transmitting the application layer measurement configuration via a first signaling radio bearer (SRB) for the RAN visible application layer measurement reports in case that the first SRB for the RAN visible application layer measurement reports is available; and
obtaining the RAN visible application layer measurement reports in the second RRC message,
wherein, in case that the first SRB for a transmission of the RAN visible application layer measurement reports is not available, the RAN visible application layer measurement reports are discarded.

14. The method of claim 13,
wherein the application layer measurement configuration includes a first configuration of the first SRB for the transmission of the RAN visible application layer measurement reports, and
wherein the first configuration indicates one of an SRB4 or an SRB5.

15. The method of claim 13, further comprising:
receiving a third RRC message including encapsulated application layer measurement reports after transmitting the application layer measurement configuration via a second SRB for the encapsulated application layer measurement reports in case that the second SRB for the encapsulated application layer measurement reports is available.

16. The method of claim 15,
wherein the application layer measurement configuration includes a second configuration of the second SRB for a transmission of the encapsulated application layer measurement reports, and
wherein the second configuration indicates one of an SRB4 or an SRB5.

17. A base station in a communication system, the base station comprising:
a transceiver; and
a processor coupled with the transceiver and configured to:
transmit a first radio resource control (RRC) message including an application layer measurement configuration,
receive a second RRC message including radio access network (RAN) visible application layer measurement reports after transmitting the application layer measurement configuration via a first signaling radio bearer (SRB) for the RAN visible application layer measurement reports in case that the first SRB for the RAN visible application layer measurement reports is available is available, and
obtain the RAN visible application layer measurement reports in the second RRC message,
wherein, in case that the first SRB for a transmission of the RAN visible application layer measurement reports is not available, the RAN visible application layer measurement reports are discarded.

18. The base station of claim 17,
wherein the application layer measurement configuration includes a first configuration of the first SRB for the transmission of the RAN visible application layer measurement reports, and
wherein the first configuration indicates one of an SRB4 or an SRB5.

19. The base station of claim 17,
wherein the processor is further configured to receive a third RRC message including encapsulated application layer measurement reports after transmitting the application layer measurement configuration via a second SRB for the encapsulated application layer measurement reports in case that the second SRB for the encapsulated application layer measurement reports is available.

20. The base station of claim 19,
wherein the application layer measurement configuration includes a second configuration of the second SRB for a transmission of the encapsulated application layer measurement reports, and
wherein the second configuration indicates one of an SRB4 or an SRB5.
